(19) United States
(12) Patent Application Publication
(10) Pub. No.: US 2014/0032137 A1
(43) Pub. Date: Jan. 30, 2014

(54) HEATING SYSTEM STATE MONITORING AND REPORTING SYSTEM AND DEVICE

(71) Applicant: Marian Gogoana, Merrimack, NH (US)

(72) Inventor: Marian Gogoana, Merrimack, NH (US)

(21) Appl. No.: 13/952,046

(22) Filed: Jul. 26, 2013

Related U.S. Application Data
(60) Provisional application No. 61/676,079, filed on Jul. 26, 2012.

(51) Int. Cl. G01F 23/00

(52) U.S. Cl. CPC G01F 23/0069
USPC 702/54

(57) ABSTRACT

A non-invasive sensing system for determining the operating state of a heating, ventilation or air conditioning (HVAC) system. The sensing system, which includes at least one acoustic or mechanical vibration sensor, may be positioned on the HVAC system's housing to detect acoustic and/or mechanical vibration emissions in one or more specific ranges of frequencies that are characteristic of emissions resulting from the operation of the HVAC system. The sensing system can also incorporate a thermal sensor, which may be placed on the HVAC system's exhaust gas pipe. A sensing unit may communicate through a network with a server for computing system statuses and fuel consumption. The server may provide usage and efficiency information to subscriber devices and send out-of-range alerts to subscribers.

### CROSS REFERENCE TO RELATED APPLICATIONS

This application claims priority to U.S. provisional application No. 61/676,079, filed Jul. 26, 2012, the contents of which are hereby incorporated herein in their entirety.

### BACKGROUND

The invention relates to a system for determining the operating states of building and premises heating systems, and to a method for determining these operating states and for providing further actionable information based on the states. In one aspect, the invention relates to a system employing vibration sensors and/or thermal sensors to determine the operating states of a premises heating system and to determine fuel usage and efficiencies.

In one aspect, the invention can assist in reducing the amount of fossil fuel (e.g., natural gas, oil, propane) burned each year for heating buildings. In one aspect, the invention can assist a building owner or operator in becoming aware of key efficiency metrics previously very difficult to obtain. Building owners are thereby empowered to make better decisions, reduce their energy use and save money.

Studies have shown an energy usage reduction of up to 17% because homeowners are simply able to see a live dashboard of their energy consumption and track the impact of their behavior. The present invention makes this possible for oil, gas and propane heating.

Embodiments of the present invention avoid the shortcomings of smart thermostats, which only have one-way communication with the heating system. A thermostat only knows how long it has commanded the heating system to turn on; it cannot know exactly how long the flame was on and how much fuel was consumed.

### SUMMARY OF INVENTION

According to one embodiment of the present invention, there is provided a premises sensing unit for monitoring HVAC system fuel consumption, having a vibration transducer interfaced to logic circuitry. The logic circuitry is configured to infer fuel-consuming states of an HVAC central unit based on signals from the vibration transducer and store, in a memory, time of fuel-consuming state information based on the inferred fuel-consuming states. The vibration transducer may be placed on an exterior of the HVAC central unit to detect the vibrations.

According to another embodiment, the premises sensing unit logic circuitry includes a processor, the memory, an analog to digital converter and interface circuitry interfacing the processor, memory, and analog to digital converter. The interfacing of the vibration transducer to the logic circuitry is through the analog to digital converter. The memory includes a firmware section storing processor instructions for the functions of inferring fuel-consuming states and storing time of fuel-consuming state information. In some embodiments, the logic circuitry further includes a network interface and the firmware includes code for transmitting time of fuel-consuming state information through the network via the network interface. The network interface may include a radio and employ a radio-based network protocol such as a WiFi protocol.

In certain embodiments, the code for carrying out the function of inferring fuel-consuming states may implement a discrete Fourier transform of periodic samples from the analog to digital converter to create a sample spectrum and infer fuel-consuming states based on the presence or absence of a sample spectrum frequency in a trigger range and having at least a minimum amplitude. The firmware may also include code for a training module to identify a trigger frequency as the frequency sensed by the vibration transducer having the highest amplitude signal within a selected frequency range and lasting at least a specified duration. Once identified, the training module, stores the trigger frequency and its amplitude as the trigger frequency and minimum amplitude, respectively. In a preferred embodiment, the training frequency range is 50 to 2,000 Hz, the trigger range is the trigger frequency ±1%, and the training duration period is at least 30 seconds. In some embodiments, the firmware section includes code for receiving and installing a firmware update.

In some embodiments, the logic circuitry and vibration sensor are disposed in a housing having an integral magnet such that the sensing unit may be removably affixed to an exterior surface of the HVAC central unit. In some embodiments, the premises sensing unit may include a temperature sensor for sensing an HVAC central unit temperature change occurring when the HVAC central unit is in a fuel-consuming state; the logic circuitry may infer or confirm vibration-inferred fuel-consuming states of the HVAC central unit based on sensed temperature changes.

In another embodiment, the premises system unit is part of a system for monitoring HVAC system fuel consumption which further includes a network connected computing device having a computer readable medium storing processor instructions for a computing application; the application is configured to receive, through the network, time of fuel-consuming state information from the premises sensing unit, compute an estimated fuel consumption value based at least in part on the time of fuel-consuming state information and display the estimated fuel consumption value. The network connected computing device is configured to permit network connected client devices to download the computing application through the network.

In yet another embodiment of the present invention, the premises system unit is part of a system for monitoring HVAC system fuel consumption having a network connected computing device with a processing unit and a storage medium storing code for receiving through the network time of fuel-consuming state information from the premises sensing unit, storing the time of fuel-consuming state information in the storage medium, computing an estimated fuel consumption value based at least in part on the time of fuel-consuming state information, and transmitting the estimated fuel consumption value through the network.

In yet another embodiment of the present invention, there is provided a system including a processor, a network interface coupled to a network, and a non-transitory storage medium storing code. When the code is executed by the processor, the code causes the system to receive, through the network, time of fuel-consuming state information from premises sensing units, each associated with and inferring fuel consumption of an HVAC system in a premises. The code also causes the system to store the time of fuel-consuming state information in the storage medium and compute estimated fuel consumption values based at least in part on the time of fuel-consuming state information. The code also causes the system to transmit the estimated fuel consumption values through the network to network connected client devices.

In one embodiment, the code also causes the system to receive, through the network from a network connected client device, client information for one of the premises sensing units associated with a selected HVAC system. The client information includes a geographic location indicator of the HVAC system, an indicator of an amount of space conditioned by the HVAC system, and a capacity indicator of the HVAC system. The capacity indicator may be the make and model identifiers or the rated heating/cooling capacity of the selected HVAC system. The computed estimated fuel consumption values are further based on at least some of the client information. The client information may further include an indication of a fuel type for the selected HVAC system.

In one embodiment, the client information further includes an indication of a fuel tank capacity and an indication of present fuel level for the selected HVAC system; computing estimated fuel consumption values further includes computing an estimated remaining fuel level based on computed estimated fuel consumption, the indication of fuel tank capacity and the indication of present fuel level.

In some embodiments, a network connected client device requests usage information for a selected HVAC system and the code for computing estimated fuel consumption values is executed in response to the request, the estimated fuel consumptions values pertain to the selected HVAC system, and the transmitting of the estimated fuel consumption values is to the client device.

In some embodiments, the computing of estimated fuel consumption values includes computing total fuel consumption values for selected time slices of fuel-consuming state information for a selected HVAC system, for example, the previous seven days or the previous 6 weeks. The time slices may be a selected number of previous periods of a selected duration such as hours, days, weeks, months or years.

In some embodiments, the computing of estimated fuel consumption values further includes computing average total fuel consumption values for the selected time slices for a selected stratum of the premises sensing units. The stratum may be one of, or a combination of, strata of premises sensing units (a) located in premises of a common selected type such as residential, retail, or commercial (b) located in premises having a common selected conditioned area, (c) associated with HVAC systems of a selected type, make or manufacturer, (d) located in premises in a selected geographic region and (e) associated with HVAC systems achieving a selected comparative efficiency level such as the 10% most efficient systems.

In some embodiments, there is code for analyzing the stored time of fuel-consuming state information for a selected HVAC system to determine an out-of-range condition and causing an electronic alert describing the out-of-range condition to be transmitted to a subscriber associated with the selected HVAC system. An out-of-range condition may include recent total fuel consumption above or below an expected range for a selected period. The expected range may be computed as a function of recent outdoor temperatures in the geographic region of the premises of the selected HVAC system during the selected period, prior fuel consumption rates of the selected HVAC system under prior like temperatures and variance factors such as ±5° F. and ±0.1 gal/h. An out-of-range condition may also include absence of fuel-consuming state information for the selected HVAC system. An out-of-range condition may also include an estimated remaining fuel tank level below a threshold, such as below 10% or 5% of the fuel tank capacity. Code for estimating a remaining fuel level for the selected HVAC system is a function of a previously stored fuel level for the selected system, a previously stored fuel tank capacity for the selected system and the stored time of fuel-consuming state information for the selected system for fuel consumption since the storing of the fuel level.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 illustrates exemplary on-premises components according to embodiments of the invention.

FIG. 2 illustrates an exemplary system in accordance with an embodiment of the invention.

FIGS. 3A-3B illustrate an exemplary on-premises sensing unit in schematic and perspective views, respectively, according to embodiments of the invention.

FIG. 4 is a sound spectrum graph illustrating exemplary spectra to which embodiments of the invention may be sensitive.

FIGS. 5A-5C are exemplary flow-diagrams of sensing unit operations according to embodiments of the invention.

FIG. 6 illustrates exemplary environmental vibration and acoustics timing aspects.

FIGS. 7A-H illustrate exemplary client device screens of data solicitation and reporting features in accordance with embodiments of the present invention.

FIGS. 8A-D are exemplary flow-diagrams of server-side operations according to embodiments of the present invention.

FIGS. 9 and 10 are high-level schematics of exemplary server and client devices, respectively, according to embodiments of the present invention.

### DETAILED DESCRIPTION

Aspects of the present invention relate to system and methods for determining the operating states of a premises heating system and aggregating data concerning the operation of the premises heating system so that usage and efficiency information can be reported. In one embodiment, the invention may include a sensor system that uses vibration sensors (acoustic and mechanical) and a thermal sensor, either individually or in combination, to determine the operating states of a premises heating system.

Embodiments of the present invention are compatible with natural gas, propane and oil premises heating systems. Premises for which the present invention is useful include residential homes and commercial settings such as offices and retail establishments employing compatible heating systems. From the user's perspective, deployment and use of the invention requires no specialized knowledge and can be done without professional installation.

Benefits of the invention include the ability of a home owner or business being able to measure the results and value of their energy efficiency efforts and their carbon footprint. Users are empowered to reduce energy use and save on energy costs. Additionally, users can set energy goals, track progress, and know when to service a heating system in view of efficiency losses. Users avoid being surprised by high energy bills, by knowing every day's usage, and being able to monitor fuel tank levels (for systems employing tanks such as some propane and oil systems) to avoid the surprise of running out. Users can monitor remote premises such as a vacation home and receive alerts (e.g., a text message or email) when abnormal heating system operation occur such as no heating system operation for over ten hours when outdoor temperatures are below freezing.

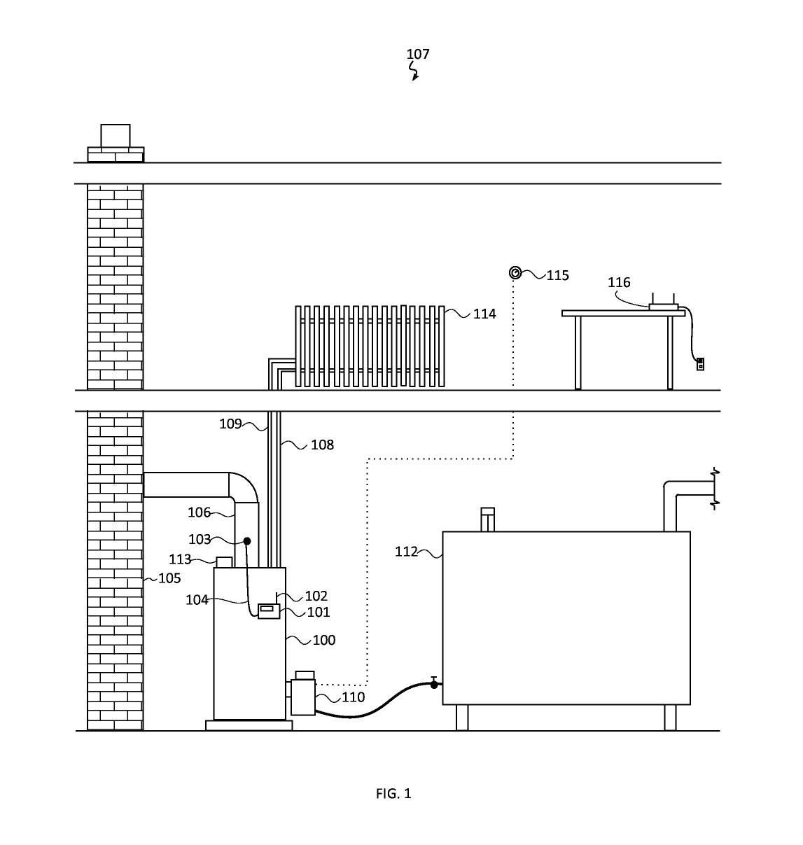

With reference to FIG. 1, an exemplary premises 107 and its heating system are illustrated. In this example, the heating system includes a boiler 100 for heating and circulating a radiator fluid such as water through supply line 108 to radiator 114 in an occupied space of the premises and through return line 109. In other premises, the heating unit may be a furnace (not shown) which heats air to be circulated in the occupied space via duct work (not shown). The boiler 100 (or furnace) may be controlled by a thermostat 115 located in the occupied space. Fuel for firing the boiler 100 (or furnace) is provided through a pipeline from a tank such as oil tank 112 or a propane tank (not shown) or alternatively, through an energy utility's fuel pipeline to the premises.

Boiler 100 (or furnace) includes a burn unit 110 in which combustion of the fuel takes place. Flue gas is vented to the exterior of the premises via a venting system such as flue 106 and chimney 105. It has been determined that when a furnace or boiler used in a premises heating operation is in an operative fuel burning state, one or more of its various components create mechanical and/or acoustic vibrations at one or more frequencies. For example, some systems may employ an inducer fan motor (not shown) for ensuring a proper flow of combustion air and having a characteristic vibration frequency detectable at the housing of boiler 100 (or furnace). In a system employing forced air, a furnace may employ a blower fan motor which also creates a characteristic vibration detectable at the housing of the furnace. In some boilers, a water circulating pump motor creates a characteristic vibration detectable at the housing of the boiler. In systems fueled by a fuel supply line at a nominal or negative pressure, there may be a fuel pump creating a characteristic vibration detectable at the housing of the system.

Referring further to FIG. 1, in one aspect of the invention, premises equipment 101 may be attached to or near the housing of boiler 100 to detect such characteristic vibrations. In one embodiment, premises equipment 101 comprises a case having integral magnets (not shown) allowing premises equipment 101 to be attached to boiler 100 (or furnace) magnetically--akin to a refrigerator magnet attaching to a refrigerator. Premises equipment 101 may include a thermal sensor 103, for placement on or near the boiler 100 (or furnace) in an area such as exhaust flue 106 which becomes hot when the boiler 100 (or furnace) is in a fuel burning state, connected via thermal sensor connector 104. In one embodiment, premises equipment 101 may also communicate with other components via a network connection, which may include a WiFi or other radio-based network connection using antenna 102. In a radio-based network connection, there may optionally be an on-premises WiFi access point such as WiFi access point 116 for relaying heating system state information from premises device 101 to other components in the system.

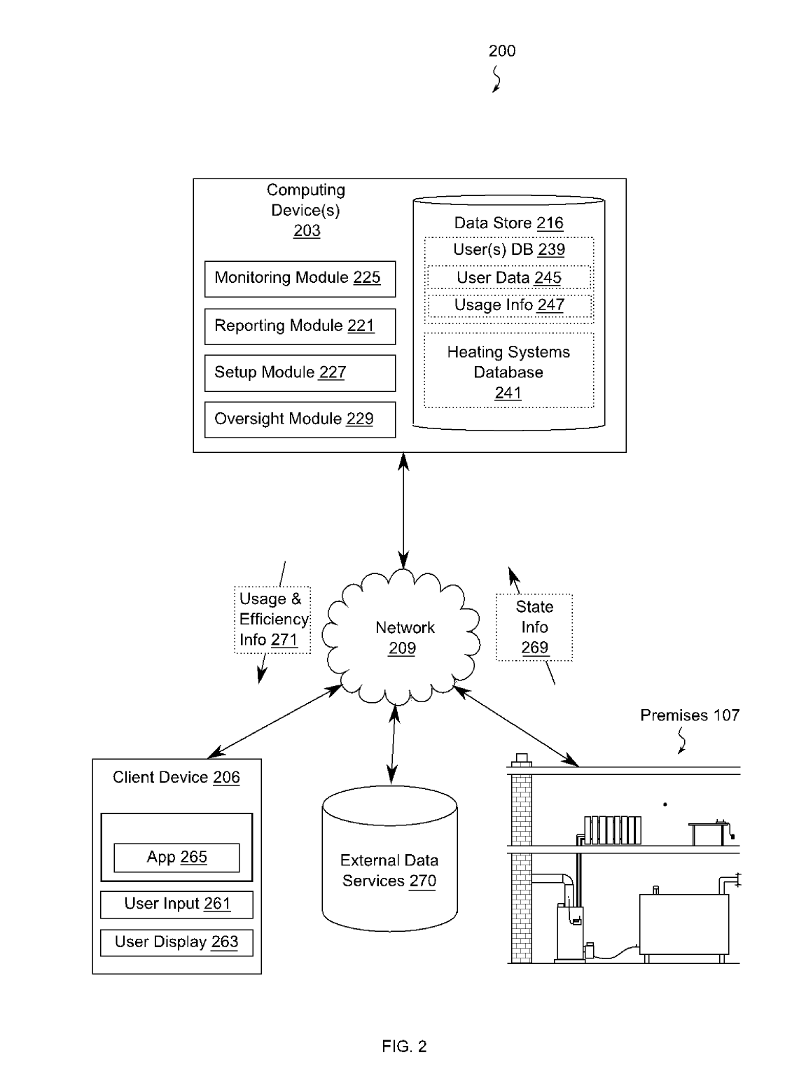

Referring now to FIG. 2, in one embodiment, aspects of the invention may comprise system 200, which may include premises 107, network 209, computing device 203 and client device 206. Premises equipment 101 may be configured to transmit heating system state information 269 through the network 209 to computing device 203 for storage and/or analysis. Computing device 203 may be, for example, a server computer attached to the internet. Modules on computing device 203 may include a monitoring module 225, reporting module 221, setup module 227 and oversight module 229.

The computing device 203 may comprise, for example, a server computer or any other computing device or system providing computing capability. The computing device 203 may represent multiple computer systems arranged, for example, in one or more server banks or other arrangements. To this end, the computing device 203 may comprise, for example, a cloud computing resource, a grid computing resource, and/or any other distributed computing arrangement. Such computer systems may be located in a single installation or may be dispersed among many different geographical locations. For purposes of convenience, the computing device 203 is referred to herein in the singular. However, in one embodiment, the computing device 203 represents a plurality of computer systems arranged as described above.

Various applications and/or other functionality may be executed in the computing device 203 according to various embodiments. For example, computing device 203 may also function as a web server, executing web server software such as the Apache web server application. Also, various data is stored in a data store 216 that is accessible to the computing device 203. The data store 216 may be representative of a plurality of data stores as can be appreciated. The data store 216 may also be implemented in one or more computing devices separate from computing devices in which the other applications described herein are executed. The data stored in the data store 216, for example, is associated with the operation of the various applications and/or functional entities described below.

The data store 216 can include information about users 239 having premises equipment 101. Each of the users 239 can be associated with user data 245. The user data 245 can include a user's identity information, such as, for example, email address, zip code, heated home surface, furnace/boiler id label, whether the heating system is one stage, two stages, or variable load furnace and house orientation. The data store 216 can include information about HVAC systems in database 241. Database 241 may contain heating/cooling system capacities, fuel consumption rates and other performance data concerning various HVAC systems, indexed by make and model.

Monitoring module 225 may be configured to receive users' state information 269 and store it in data store 216 as usage information 247. Note that in one embodiment, there may be many premises 107, each being associated with a distinct user 239, each having premises equipment 101 detecting heating system state information and transmitting that to computing device 203. In such multi-user embodiments, usage information 247 is stored in user 239-distinct areas of data store 216.

Computing device 203 may further comprise reporting module 221, which is configured to analyze usage information 247, perhaps in combination with data obtained from external data services 270, and report usage and analysis information such as usage and efficiency information 271 to a client device such as client device 206. External data services 270 may be representative of a number of distinct external data services, providing data such as weather information, local fuel pricing information, and heating system heating capacity information for various makes and models of heating systems.

The client device 206 is representative of a plurality of client devices 206 that may be coupled to the network 209. The client device 206 may comprise, for example, a processor-based system such as a computer system. Such a computer system may be embodied in the form of a desktop computer, a laptop computer, a personal digital assistant, a mobile device (e.g., a cellular telephone, smart phone, etc.), a web pad, a tablet computer system, or another device with like capability. The client device 206 includes a display device 263 upon which various information may be displayed.

The client device 206 may be configured to execute various applications such as a browser application, an invention-specific application 265, and/or other applications. A browser application may be executed in a client device 206, for example, to access and render content pages, such as web pages, or other network content served up by the computing device 203 and/or other servers. The application 265 may be executed in a client device 206 to capture user setup data or present usage and efficiency information 271.

The client device 206 may be configured to execute applications beyond a browser or application 265 such as, for example, an email client, instant message applications, an SMS client and/or other applications as can be appreciated.

Computing device 203 may further comprise setup module 227, which is configured to receive and store client setup information in data store 216. Such client setup information may be entered by a user using client device 206 and its user input features 261 (e.g., keyboard, touch pad, mouse, etc.).

Computing device 203 may further comprise oversight module 229, which is configured to determine out-of-range operations of a user's heating system based on a periodic analysis of usage information 247 or the absence of such information. If an out-of-range condition is detected, oversight module 229 may initiate a notification protocol to the user via, for example, e-mail or text message.

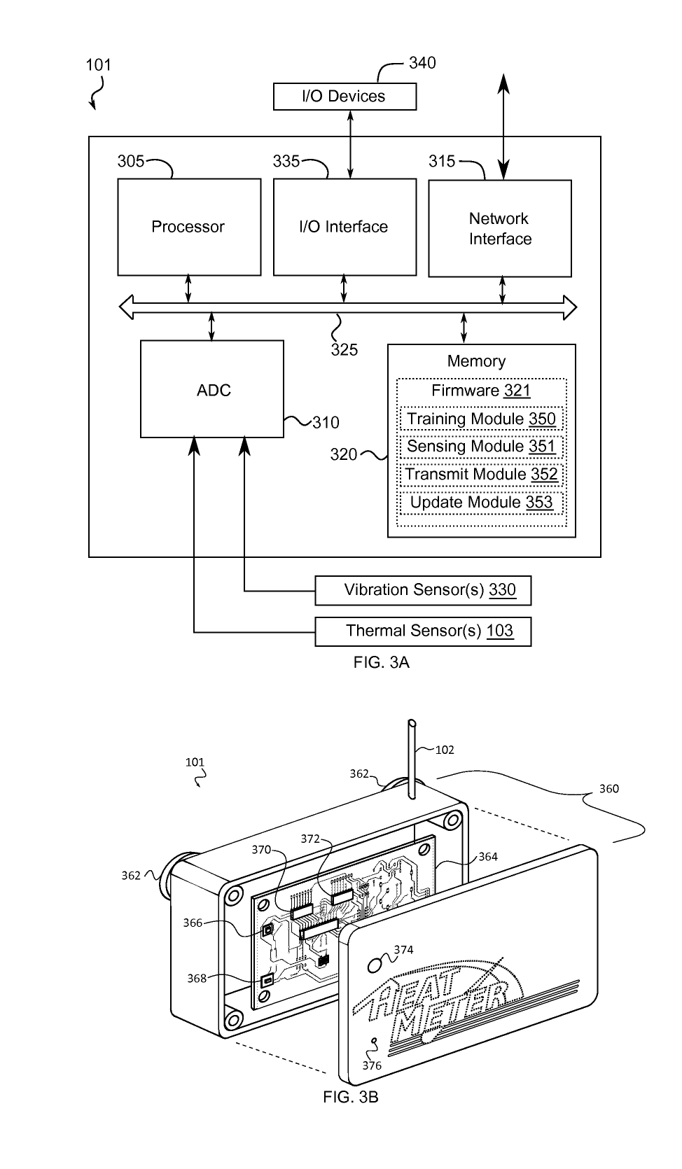

With reference now to FIG. 3A, more detail is provided of an aspect of an exemplary embodiment of the invention. As illustrated, premises device 101 may comprise electronic components such as processor 305, analog to digital converter 310, network interface 315 and memory 320. Each of these may be attached to an internal bus such as bus 325. In an exemplary embodiment, these components may comprise a programmable microcontroller such as microcontroller 370 illustrated in FIG. 3B. The network interface may be configured to communicate through network 209 to other components in the network such as computing device 203 and client device 206. Premises device 101 may further include one or more vibration sensors 330 coupled through analog to digital converter 310. Vibration sensors 330 may be adapted to sense vibrations through acoustic, mechanical and/or accelerometer means. Additionally, premises device 101 may include one or more thermal sensors 103 which may be placed on or near an area of the heating system which becomes hot when the heating system is in a fuel consuming state.

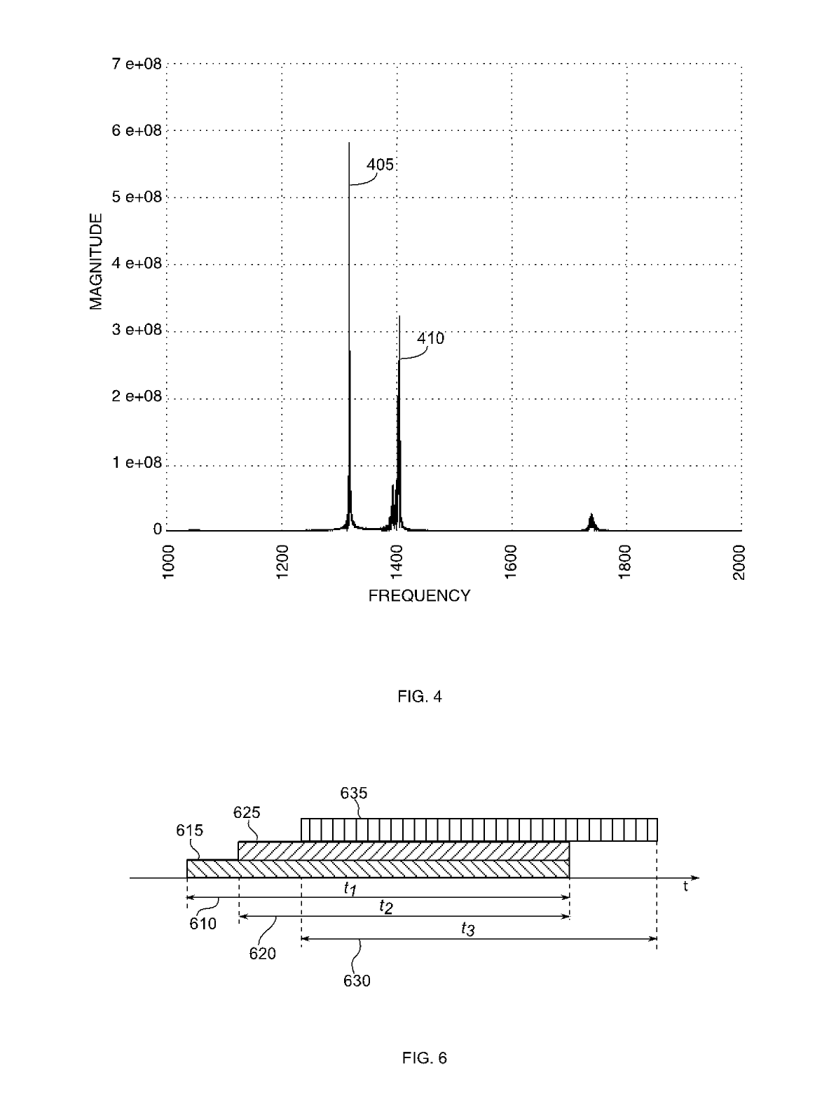

In an exemplary embodiment, processor code may be stored in firmware section 321 of memory 320 which, when executed by processor 305, causes the premises device 101 to “listen” for vibrations in the premises device 101 environment and infer that a heating system is in a fuel consuming state and store fuel consumption state information in memory 320 and/or transmit it through network interface 315 to a computer on the network. Such code may comprise sensing module 351 and transmit module 352. In one embodiment, sensing module 351 includes code which, when executed by processor 305, computes a discrete Fourier transform of periodic samples of the analog to digital converter 310 port coupled to transducer 330. In a preferred embodiment, the transform is computed with a fast Fourier transform algorithm selected in part based on the architecture of processor 305. The resulting frequency spectrum is weighted so that vibration frequencies in the 50 to 2,000 Hz range are preferred. For example, with reference to FIG. 4, premises device 101 may be configured to detect vibrations such as those having a characteristic frequency of roughly 1320 Hz indicated as peak 405 in the graph and a characteristic frequency of around 1400 Hz indicated as peak 410 in the graph.

As illustrated in FIG. 3A, some embodiments of premises device 101 may comprise an input/output interface 335 coupled to one or more input/output devices 340. Input/output devices 340 may include one or more switches, such as reset button 368 illustrated in FIG. 3B, and one or more indicators such as LED 366 as illustrated in FIG. 3B to indicate status and current operations of device 101. For example LED(s) may indicate training, sensing, updating, network connectivity and data transmitting. As illustrated in FIG. 3B, button 368 and LED 366 may be disposed on circuit board 364 with other device 101 components and mounted in a case 360 with integral magnets 362. A cover portion of case 360 may include a translucent portion 374 through which LED 366 may be observed and a reset button hole 376 under which reset button 368 may be disposed. In various embodiments, device 101 may be powered (not shown) by an AC adaptor, a battery interior or exterior to the housing, or a thermoelectric device attachable to, e.g., an HVAC exhaust pipe and providing current due a temperature differential.

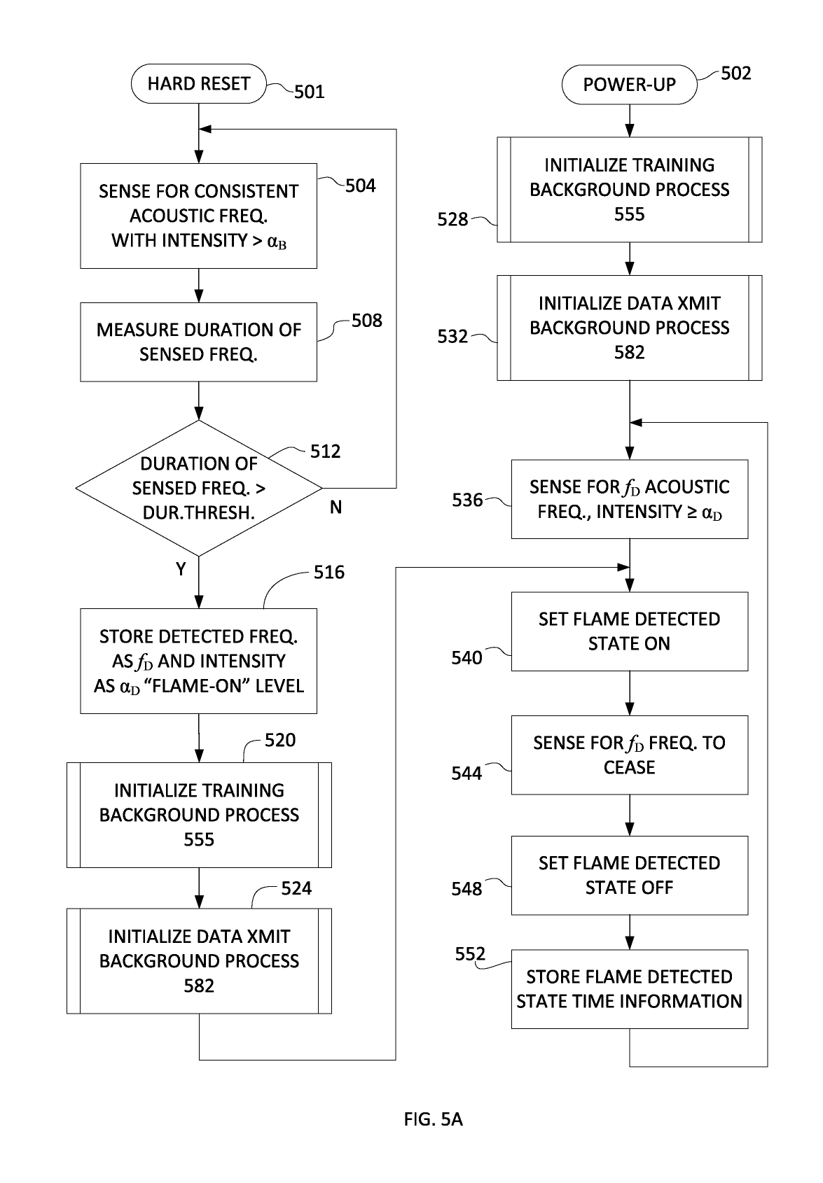

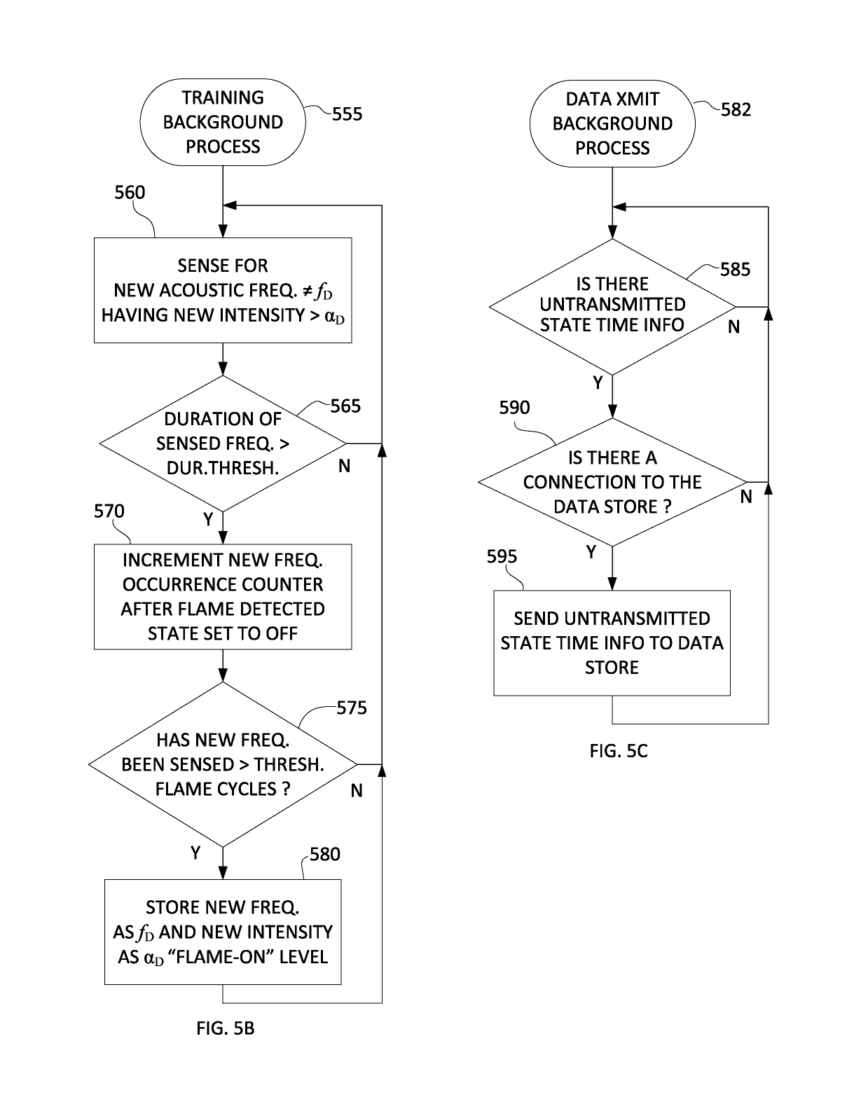

With reference to FIGS. 5A, 5B and 5C, premises device 101 may be configured to “learn” pertinent frequencies and amplitudes, infer fuel consumption states, and transmit and/or store fuel consumption state information. FIG. 5A provides an exemplary illustration of steps that may be taken upon a “hard reset” condition 501 which might occur upon the first power-up of premises device 101 or upon pressing a reset button (not shown) on the premises device 101. After a “hard reset” 501, device 101 may enter sensing state 504 to sense for a vibration having a consistent frequency and an intensity or amplitude greater than a predetermined threshold, α_{B}, for example. Once such a vibration is detected, device 101 may enter a state 508 of measuring the duration of the sensed vibration. If the duration is greater than a preset duration threshold T_{D} as assessed at decision point 512, then device 101 will store the detected frequency as f_{D} and store the measured amplitude of f_{D} as α_{D}, the “flame-on” level, in step 516. In one embodiment, T_{D} is 30 seconds.

Once the frequency and threshold have been so identified and stored, device 101 may initiate a background retraining process 555 in step 520 and a background data transmission process 582 in step 524.

Having identified pertinent vibrations, device 101 will set a “flame detected state” to “on” in step 540 and then enter sensing step 544 to sense for cessation of the f_{D} vibration. Once this occurs, device 101 will set the “flame detected state” to “off” in step 548 and store flame detected state time information in step 552. In some embodiments, such information may include time on, time off and duration. After step 552, the device will cycle to step 536 to sense for a vibration having a frequency of f_{D} and an intensity or amplitude greater than α_{D}.

In non-“hard reset” conditions, i.e., ordinary power-up condition 502, the device may initiate background retraining process 555 in step 528 and background data transmission process 582 in step 532 and then enter sensing state 536. In sensing state 536, device 101 will sense for a vibration having a frequency of f_{D} and an intensity or amplitude of at least α_{D}. Once this vibration is detected, device 101 will enter step 540 and follow the steps described in the previous paragraph.

Referring to FIG. 5B, an exemplary retraining background process 555 is illustrated. In step 560, device 101 may sense for a vibration having a frequency distinct from f_{D} and an intensity or amplitude greater than α_{D}. If such a vibration is detected and it has a duration of at least the duration threshold T_{D} as determined in decision point 565, a new frequency occurrence counter may be incremented in step 570 following a setting of the “flame detected state” to “off”. If the new frequency has been detected more than a preset threshold number of times, e.g., detected at least twice, as determined at decision point 575, in step 580, device 101 will store the new detected frequency as f_{D} and store its measured amplitude as α_{D}, the retrained “flame-on” level.

In some embodiments, training for a “flame detected state” “on” condition may include a step of determining whether thermal sensor 103 is detecting a temperature at or above a preset threshold Temp_{D}. This thermal confirmation training step may be incorporated in, for example, decision points 512 and/or 565. Code for carrying out the steps 504-516 as shown in FIG. 5A and steps 560-580 as illustrated in FIG. 5B may be stored in firmware 321 training module 350.

With reference to FIG. 5C, in some embodiments, there may be a background data transmission process 582. This process determines in steps 585 and 590 whether there is untransmitted state time information and whether there is a connection, e.g., a network connection, to an external data store. If so, device 101 will transmit the untransmitted state time information 269 to the data store in step 595. As can be appreciated, once transmitted, device 101 can mark the state time information as transmitted or delete it from local storage. In alternative operations, device 101 may be polled through network 209 and/or transmit state time information 269 in response to commands or polling received through network 209. Code for carrying out the steps 585-595 as shown in FIG. 5C may be stored in firmware 321 as transmit module 352.

Referring to FIG. 6, a timing diagram illustrating the timing of various vibrations in the environment of device 101 is provided. For example, a boiler or furnace may have an inducer fan or positive draft fan which is cycled “on” first and which creates vibrations in relative sequence as represented by bar 615. Once a draft is created, the system may ignite the burner and the burning of fuel creates vibrations in relative sequence as represented by bar 625. Once burning has commenced, a system may enable a blower or pump which creates yet additional vibrations in relative sequence as represented by bar 635. In the example of FIG. 6, any of the vibrations 615, 625 and 635, may serve as a proxy for a fuel consuming state so long as their respective durations, t₁ 610, t₂ 620 and t₃ 630 and their amplitudes meet the training criteria, e.g., T_{D}, α_{B}, α_{D} and f_{D}, discussed above.

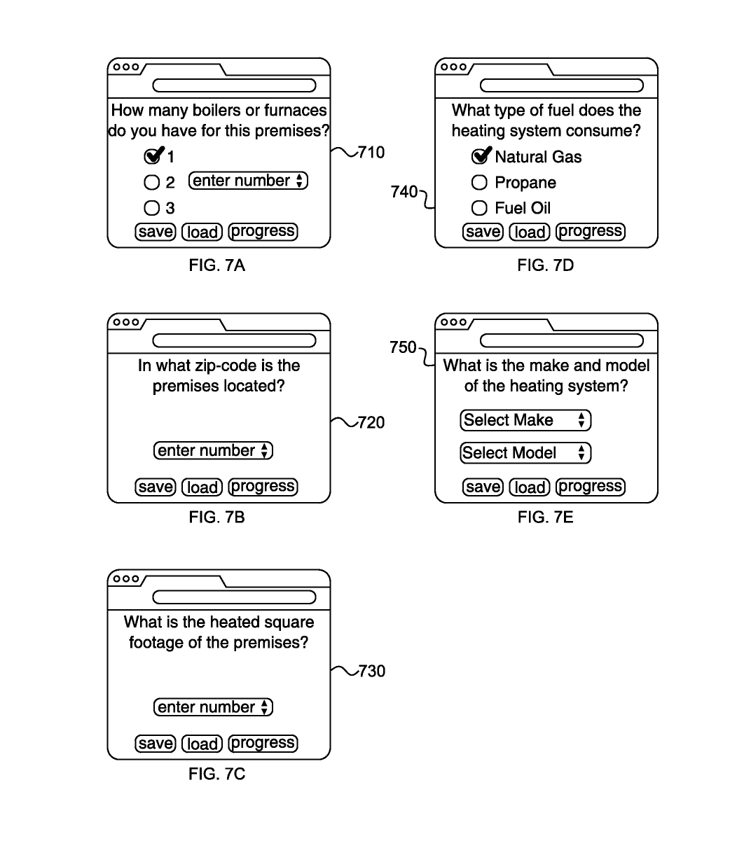

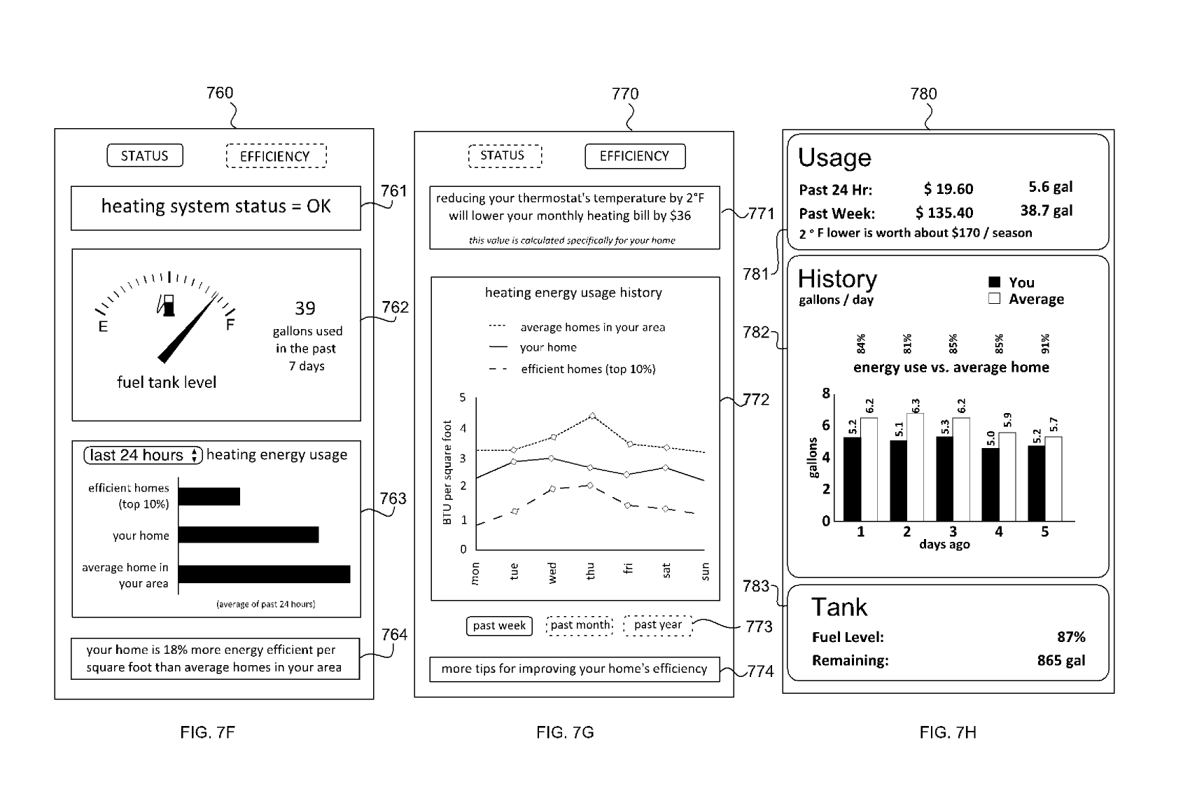

With reference now to FIGS. 7A-7E, there are illustrated exemplary data entry screens in accordance with an embodiment of the present invention. Such screens may be rendered on client device 206. The screens may be specified by setup module 227 in, for example, HTML transmitted to client device 206. Alternatively, client device 206 may be executing an application such as application 265 which is configured to render screens prompting a user for information. Computing device 203 may be executing a setup module 227 configured to receive and store setup related information entered by the user on client device 206 via user input 261.

For example, as shown in FIG. 7A, an input screen 710 may solicit information concerning the number of heating systems on the premises; another input screen 720, as shown in FIG. 7B may solicit the location of the premises, which may be indicated by a postal code or geo coordinates computed by client device 206. FIG. 7C illustrates a data entry screen 730 soliciting the heated square footage of the premises. FIG. 7D illustrates a data entry screen 740 soliciting a fuel type for the heating system and FIG. 7E illustrates a data entry screen 750 soliciting make and model information for the heating system. In one embodiment, the rated heating capacity of the unit, e.g., BTU/h, gal/h or KW, may be solicited on a data entry screen (not shown) in lieu of or in addition to the make and model information. In one embodiment, the capacity of a fuel tank and its present fill, i.e., a tank volume and volume of fuel therein, may be solicited on a data entry screen (not shown); these data values can be used to provide a user with information and alerts about remaining fuel. It can be appreciated that the screens of FIGS. 7A-7E may be combined into fewer screens or a single screen. It can be also appreciated that the screens may utilize data entry widgets suitable for the solicited data, including, for example, drop-down lists, radio buttons, dials, key pads, sliders, etc.

With reference now to FIGS. 7F-7H, there are illustrated exemplary reporting screens in accordance with an embodiment of the present invention. Such screens may be rendered on user display 261 of client device 206. The screens may be specified by reporting module 221 in, for example, HTML transmitted to client device 206. Alternatively, client device 206 may be executing an application such as application 265 which is configured to render screens based on data values transmitted to client device 206 by reporting module 221.

Referring now to FIG. 7F, an exemplary status display 760 is shown. Status display 760 may include an overall status indicator 761 which is based on an analysis of usage data indicating that the heating system is “OK” or is not operating within ranges typical for the system given, for example, weather in the premise's locale. Display 760 may further include, where the user's system includes a fuel tank, a fuel tank level display 762. This provides the user a quick visual indication of how much fuel remains. Display 762 may also include a recent usage indicator such as that shown in FIG. 7F indicating 39 gallons of use in the past 7 days. Display 760 may also include recent energy usage display 763 which may provide a visual display of recent energy usage for a selected duration compared to average use and most efficient uses by similar structures in the locale. Display 760 may also include efficiency statement display 764 which may provide a comparative efficiency summary.

Referring now to FIG. 7G, an exemplary efficiency display 770 is shown. Efficiency display 770 may include an efficiency incentive statement 771, computed specifically for the user's premises based on the user's system type, local fuel prices and efficiency computations based on the user's inferred fuel consumption. Efficiency display 770 may also include a comparative heating history display 772 graphically indicating the user's energy use compared with average and efficient premises. Display 772 may permit the user to select the history period with one or more duration buttons 773. Display 770 may also include efficiency link area 774 which, when selected by the user, will transition the display to an informational page (not shown) containing information related to the text in link area 774.

FIG. 7H illustrates an exemplary alternative usage display 780. Usage display 780 may contain a recent fuel consumption display 781 to indicate the cost and amount of fuel used in recent periods. Usage display 780 may also contain display 782 showing comparative energy usage over a recent period. Also, in systems having fuel tanks, usage display 780 may include a tank level display 783 for reporting to the user the estimated amount of fuel in the user's system's fuel tank.

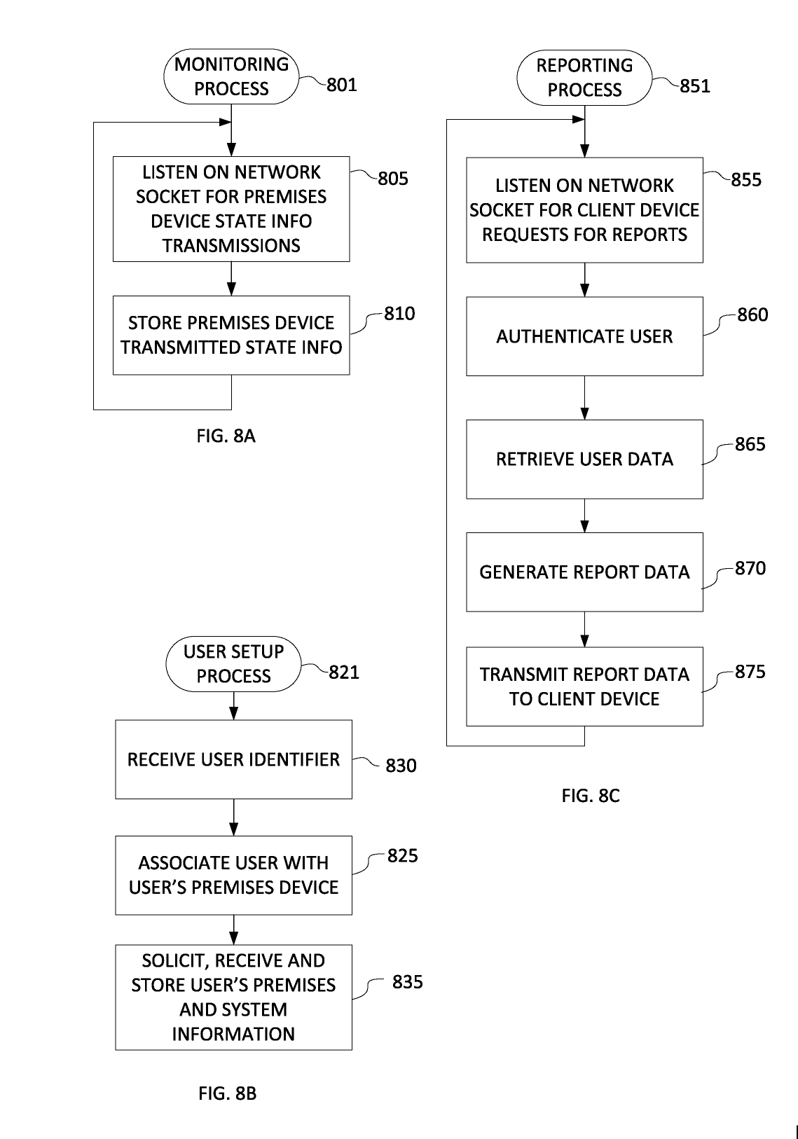

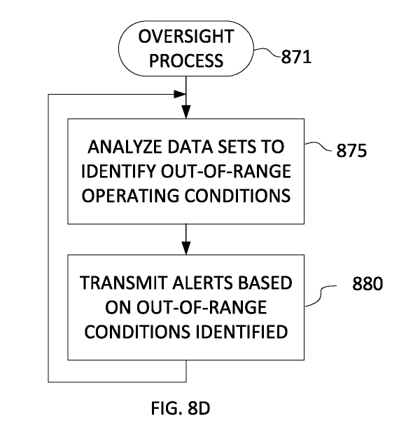

With reference to FIGS. 8A-8D, exemplary flow-diagrams of processes for computing device 203 are illustrated. FIG. 8A illustrates a monitoring process 801 for carrying out the function of monitoring module 225. Process 801 may include a step 805 of listening on a network socket for transmissions of state information 269 from a premises device 101. In an alternative embodiment, process 801 may include a step (not shown) of polling a premises device 101 for state information 269. Process 801 further includes a step 810 of storing state information 269, once received, in data store 216 as usage information 247.

Referring now to FIG. 8B, an exemplary flow-diagram for a user setup process 821 for carrying out the function of setup module 227 is illustrated. Process 821 may include a step 830 of receiving user identification information such as a user-id and a step 825 of associating a user with the user's premises device. Setup process 821 may further include a step 835 of soliciting, receiving and storing information such as the number of heating systems on the premises, the location of the premises, which may be indicated by a postal code or geo coordinates, the heated square footage of the premises, a fuel type for the heating system, the rated heating capacity of the unit, the make and model of the unit, and the capacity of a fuel tank and its present fill. Step 835 may include soliciting, receiving and storing user alert preference information such as an e-mail address, an SMS address or phone number. Information obtained in step 835 may be stored in the user data area 245 of the user database 239 in data store 216.

Referring now to FIG. 8C, an exemplary flow-diagram for a reporting process 851 for carrying out the function of setup module 221 is illustrated. Process 851 may include a step 855 of listening for a user client device request for a report, a step 860 of authenticating the user, a step 865 of retrieving user and usage data, a step 830 of computing and generating reportable usage and efficiency information, and a step 875 of transmitting the same to a client device. It can be appreciated in conjunction with FIGS. 7G-7I that comparative usage information is based on aggregating and analyzing other users' usage information.

Referring now to FIG. 8D, an exemplary flow-diagram for an oversight process 871 for carrying out the function of oversight module 229 is illustrated. Process 871 may include a step 875 of analyzing data sets, e.g., usage information 247, for out-of-range conditions. Such conditions may include, for example, a fuel-tank near empty condition, a premises device 101 failing to transmit state information 269, excessive fuel consumption periods and periods of unexpectedly low fuel consumption. The analysis step 875 may take into consideration temperatures in the locales of the various premises devices and prior fuel consumption of the heating system under like conditions within an appropriate variance range. Once an out-of-range condition is identified, oversight process 871 may execute an alert transmission to the affected user in step 880. Such alert transmissions may be to a user via text message, short-message-service, automated voice messaging, and/or e-mail.

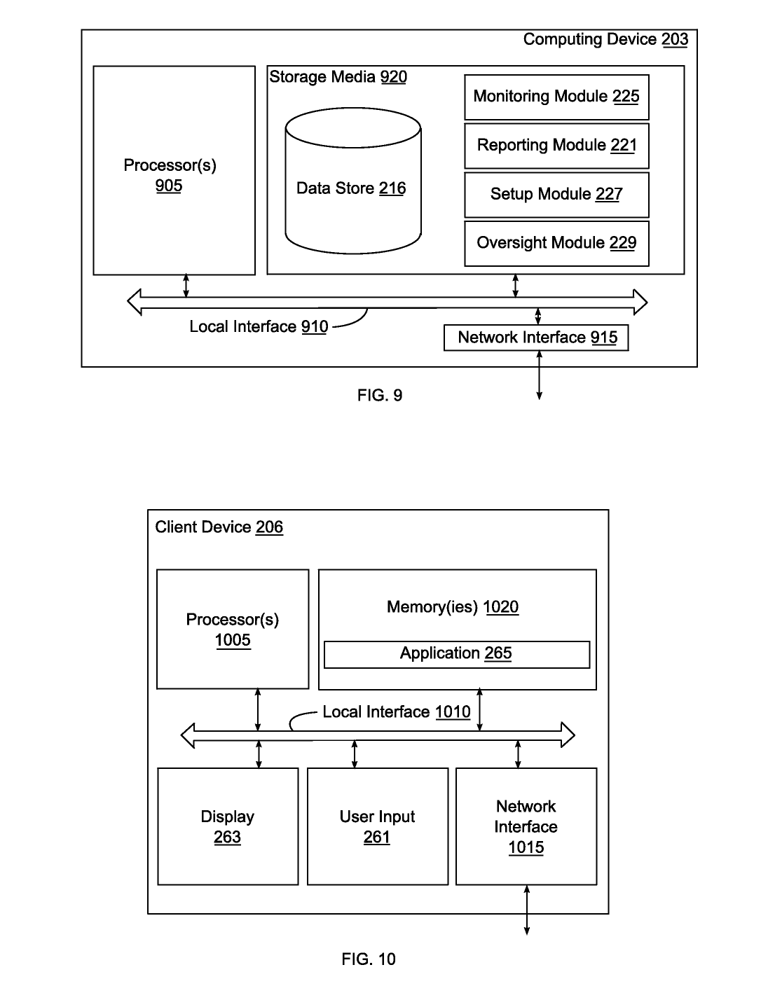

Referring next to FIGS. 9 and 10, shown are schematic block diagrams of an exemplary computing device 203 and exemplary client device 206, respectively, according to an embodiment of the present disclosure. The computing device 203 and client device 206 include respective processors 905, 1005 and memory(ies)/storage media 920, 1020, both of which are coupled to local interfaces 910, 1010. The local interface 910, 1010 may comprise, for example, a data bus with an accompanying address/control bus or other bus structure as can be appreciated. The client device 206 includes a display 263 coupled to the local interface 1010 to allow the processor 1005 to apply visual data to the display 263, such as a user interface generated by the application 265. In some embodiments, the computing device 203 and/or client device 206 can include other elements that are coupled to their respective local interfaces 910, 1010 such as a location system configured to obtain location or position data and other systems as can be appreciated. In addition, the client device 206 may include input devices 261 such as a touchscreen, keyboard, toggles, mouse and push buttons. Computing device 203 and client device 206 further include a network interface 915, 1015, coupled to local interface 910, 1010. Network interface 915, 1015 is adapted to allow computing device 203 and client device 206 to communicate with each other and other network resources through, for example, network 209 (see FIG. 2) which may be the internet, an intranet or other network system. Network interface 915, 1015 may employ a protocol such as TCP/IP and may communicate on a medium such as WiFi, wired Ethernet or other network media.

Stored in the respective memories 320, 920, 1020 are several components that are executable by the processors 305, 905, 1005. In particular, stored in the memory 920 of the computing device 203 are the monitoring module 225, reporting module 221, setup module 227 and oversight module 229. Stored in the memory 1020 of the client device 206 may be the application 265 and other data and applications. Stored in the memory 320 of premises device 101 are computer instructions for carrying out vibration sensing, training, updating and data transmission functions. It is understood that there may be other applications that are stored in the memory 320, 920, 1020 and are executable by the respective processors 305, 905, 1005 as can be appreciated. Where any component discussed herein is implemented in the form of software, it may be in the respective machine code of processor 320, 920, 1020 or based upon a source programming language such as, for example, C, C++, Java, Java Script, Perl, PHP, Python, Flash, and/or other programming languages.

A number of software components are stored in the respective memories 320, 920, 1020 and are executable by the respective processors 305, 905, 1005. In this respect, the term “executable” means a program file that is in a form that can ultimately be run by the processors 305, 905, 1005. Examples of executable programs may be, for example, a compiled program that can be translated into machine code in a format that can be loaded into a random access portion of the memory 320, 920, 1020 and run by a respective processor 305, 905, 1005, source code that may be expressed in proper format such as object code that is capable of being loaded into a random access portion of the memory 320, 920, 1020 and executed by a processor 305, 905, 1005, or source code that may be interpreted by another executable program to generate instructions in a random access portion of the memory 320, 920, 1020 to be executed by a processor 305, 905, 1005, etc. An executable program may be stored in any portion or component of the memory 320, 920, 1020 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 320, 920, 1020 is defined herein as both volatile and nonvolatile memory and data storage components. Volatile components are those that do not retain data values upon loss of power. Nonvolatile components are those that retain data upon a loss of power. Thus, the memory 320, 920, 1020 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 305, 905, 1005 may represent multiple processors and the memory 320, 920, 1020 may represent multiple memories that operate in parallel. In such a case, the local interface 325, 910, 1010 may be an appropriate network that facilitates communication between any two of the multiple processors, between any processor and any one of the memories, or between any two of the memories etc. The local interface 325, 910, 1010 may comprise additional systems designed to coordinate this communication, including, for example, performing load balancing. The processor 305, 905, 1005 may be of electronic or of some other available construction.

Although various systems and applications mentioned above may be depicted as being embodied in software or code executed by general purpose hardware such as processor-based systems as discussed above, as an alternative the same may also be embodied in dedicated hardware or a combination of software/general purpose hardware and dedicated hardware. If embodied in dedicated hardware, such systems and applications can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable circuits such as field programmable gate arrays (FPGAs) or other components, etc.

The flowcharts of FIGS. 5A-5C and 8A-8D show the architecture, functionality, and operation of an implementation of the monitoring module 225, reporting module 221, setup module 227, oversight module 229, training module 350, sensing module 351 and transmit module 352. If embodied in software, each block may represent a module, segment, or portion of code that comprises program instructions to implement the specified logical function(s). If embodied in hardware, each block may represent a circuit or a number of interconnected circuits to implement the specified logical function(s).

Although the flowcharts of FIGS. 5A-5C and 8A-8D show a specific order of execution, it is understood that the order of execution may differ from that which is depicted. For example, the order of execution of two or more blocks may be scrambled relative to the order shown. Also, two or more blocks shown in succession in FIGS. 5A-5C and 8A-8D may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where various systems and applications described herein comprise software or code, each can be embodied in any tangible, non-transitory computer-readable medium for use by or in connection with an instruction execution system such as, for example, a processor in a computer system or other system. In this sense, such systems or applications may comprise, for example, statements including instructions and declarations that can be fetched from the computer-readable medium and executed by the instruction execution system. In the context of the present disclosure, a “computer-readable medium” can be any tangible, non-transitory medium that can contain, store, or maintain the above-described systems and applications for use by or in connection with the instruction execution system. The computer readable medium can comprise any one of many physical media such as, for example, electronic, magnetic, optical, or semiconductor media. More specific examples of a suitable computer-readable medium would include, but are not limited to, magnetic tapes, magnetic floppy diskettes, magnetic hard drives, memory cards, solid-state drives, Universal Serial Bus (USB) flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It has been found by the inventors that embodiments of the present invention are able to measure fuel consumption with favorable accuracy over so-called smart thermostats. For heating systems with furnaces, embodiments of the present invention were able to determine fuel consumption within ±2.6% of actual whereas a smart thermostat's estimate was ±10.2% of actual. For heating systems with boilers, embodiments of the present invention were able to determine fuel consumption within ±3.1% of actual, where as a smart thermostat had an error exceeding 50%.

It is possible to apply principles of the present invention to other heating systems such as, for example, propane or natural-gas burning pool heaters.

In one embodiment of the present invention, a module is provided for permitting “raw” data, i.e., unprocessed state time information, to be downloaded either from premises device 101 or computing device 203.

In one embodiment of the present invention, firmware 321 of premises device 101, can be remotely updated through the network. In such embodiments, the firmware may include an update module 353 comprised of processor instructions for receiving updated firmware through the network 209 and storing the updated firmware in firmware 321.

In an alternate embodiment of the present invention, client device 206 and computing device 203 can be the same computing device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A premises sensing unit for monitoring heating system fuel consumption, said premises sensing unit comprising:
a vibration transducer; and
logic circuitry interfaced to the vibration transducer, said logic circuitry configured to:
infer fuel-consuming states of a heating system burning unit based on signals from the vibration transducer, and
store, in a memory, time of fuel-consuming state information based on the inferred fuel-consuming states;
wherein the vibration transducer may be disposed to be exterior to the heating system burning unit to detect vibrations therefrom.

2. The premises sensing unit of claim 1 wherein the logic circuitry comprises:
a processor;
the memory;
an analog to digital converter; and
interface circuitry interfacing the processor, memory, analog to digital converter;
wherein the interfacing of the vibration transducer to the logic circuitry is through the analog to digital converter; and
wherein the memory includes a firmware section storing processor instructions which, when executed by the processor, cause the processor to carry out the functions of inferring fuel-consuming states and storing time of fuel-consuming state information.

3. The premises sensing unit of claim 2, wherein the logic circuitry further comprises a network interface interfacing the logic circuitry with a network and the firmware section further stores processor instructions which, when executed by the processor, cause the processor to transmit time of fuel-consuming state information through the network via the network interface.

4. The premises sensing unit of claim 3, wherein the processor instructions for carrying out the function of inferring fuel-consuming states include processor instructions:
implementing a discrete Fourier transform of periodic samples from the analog to digital converter of the signals from the vibration transducer to create a sample spectrum; and
inferring fuel-consuming states based on the presence or absence of a sample spectrum frequency in a trigger range of at least a trigger amplitude.

5. The premises sensing unit of claim 4, wherein the firmware section further stores processor instructions comprising a training module which, when executed by the processor, cause the processor to:
identify a trigger frequency from signals from the vibration transducer as the highest amplitude signal within a training frequency range, lasting at least a training duration period, and having an amplitude at least as great as a training amplitude;
storing the trigger frequency ±6 as the trigger range; and
storing the amplitude of the trigger frequency as the trigger amplitude.

6. The premises sensing unit of claim 5, where in the training frequency range is 50 to 2,000 Hz, δ is 1% and the training duration period is at least 30 seconds.

7. The premises sensing unit of claim 3, wherein the firmware section further stores processor instructions which, when executed by the processor, cause the processor to receive a firmware update through the network and update the firmware section with the firmware update.

8. The premises sensing unit of claim 1, further comprising a housing in which the logic circuitry and vibration sensor are disposed, said housing having an integral magnet disposed to permit the housing to be removably affixed to an exterior surface of the heating system burning unit.

9. The premises sensing unit of claim 3, wherein the network interface comprises a radio and employs a radio-based network protocol.

10. The premises sensing unit of claim 1, further comprising a temperature sensor for sensing a heating system burning unit temperature change wherein the logic circuitry is further configured to infer fuel-consuming states of the heating system burning unit based on sensed temperature changes.

11. A system for monitoring heating system fuel consumption comprising:
the premises sensing unit of claims 4; and
a network connected computing device having a non-transitory computer readable medium storing processor instructions for a computing application, said application configured to:
receive, through the network, time of fuel-consuming state information from the premises sensing unit;
compute an estimated fuel consumption value based at least in part on the time of fuel-consuming state information; and
display the estimated fuel consumption value;
wherein the network connected computing device is configured to permit network connected client devices to download the computing application through the network.

12. A system for monitoring heating system fuel consumption comprising:
the premises sensing unit of claim 4; and
a network connected computing device comprising a processing unit and a non-transitory storage medium storing processor instructions which, when executed by the processing unit cause the processing unit to:
receive, through the network, time of fuel-consuming state information from the premises sensing unit;
store said time of fuel-consuming state information in the storage medium;
compute an estimated fuel consumption value based at least in part on the time of fuel-consuming state information; and
transmit the estimated fuel consumption value through the network.

13. A system for monitoring heating system fuel consumption comprising:
a processor;
a network interface coupled to a network;
a non-transitory storage medium storing processor instructions which, when executed by the processor cause the processor to:
receive, through the network, time of fuel-consuming state information from a plurality of premises sensing units, each associated with and inferring fuel consumption of a heating system in a premises;
store said time of fuel-consuming state information in the storage medium;
compute estimated fuel consumption values based at least in part on the time of fuel-consuming state information; and
transmit the estimated fuel consumption values through the network to network connected client devices; and
an interface coupling the processor, storage medium and network interface.

14. The system of claim 13, wherein the processor instructions further include instructions which, when executed by the processor cause the processor to:
receive, through the network from a network connected client device, client information for a one of the plurality of premises sensing units associated with a selected heating system, said client information including a geographic location indicator of the selected heating system, an indicator of an amount of space heated by the selected heating system, and an indicator of a heating capacity of the selected heating system;
wherein computed estimated fuel consumption values are further based on at least some of the client information.

15. The system of claim 14, wherein the client information further includes an indication of a fuel type for the selected heating system.

16. The system of claim 14, wherein:
the client information further includes an indication of a fuel tank capacity and an indication of present fuel level for the selected heating system; and
computed estimated fuel consumption values include an estimated remaining fuel level based on computed estimated fuel consumption, the indication of fuel tank capacity and the indication of present fuel level.

17. The system of claim 14, wherein the indicator of a heating capacity of the selected heating system is the make and model identifiers or the rated heating capacity of the selected heating system.

18. The system of claim 13, wherein an execution of the instructions for computing estimated fuel consumption values is in response to a request from a network connected client device for usage information for a selected heating system and the transmitting of the estimated fuel consumption values is to said client device.

19. The system of claim 18, wherein the computing of estimated fuel consumption values includes computing total fuel consumption values for selected time slices of fuel-consuming state information for the selected heating system;
further wherein the time slices are a selected number of previous periods of a selected duration, said selected duration being hours, days, weeks, months or years.

20. The system of claim 19, wherein the computing of estimated fuel consumption values further includes computing average total fuel consumption values for the selected time slices for a selected stratum of the plurality of premises sensing units selected from the strata consisting of premises sensing units (a) located in premises of a common selected type, (b) located in premises having a common selected heated area, (c) associated with heating systems of a selected type, make or manufacturer, (d) located in premises in a selected geographic region and (e) associated with heating systems achieving a selected comparative efficiency level.

21. The system of claim 13, wherein the processor instructions further include instructions which, when executed by the processor cause the processor to:
analyze the stored time of fuel-consuming state information for a selected heating system to determine an out-of-range condition; and
cause an electronic alert to be transmitted to a subscriber associated with the selected heating system, said electronic alert describing the out-of-range condition;
wherein the out-of-range condition is one of:
recent total fuel consumption outside an expected range for a selected period, where the expected range is a function of recent outdoor temperatures in a geographic region of the premises of the selected heating system during the selected period, prior fuel consumption rates of the selected heating system under prior like temperatures and a variance factor; or
absence of fuel-consuming state information for the selected heating system.

22. The system of claim 13, wherein the processor instructions further include instructions which, when executed by the processor cause the processor to:
compute a remaining fuel level for a selected heating system in consideration of a previously stored fuel level for the selected heating system, a previously stored fuel tank capacity for the selected heating system and the stored time of fuel-consuming state information for the selected heating system for fuel consumption since the storing of the fuel level; and
causing an electronic alert indicating a low fuel level to be transmitted to a subscriber associated with the selected heating system if the computed remaining fuel level falls beneath a pre-determined threshold.
